(19) United States
(12) Patent Application Publication
(10) Pub. No.: US 2024/0079731 A1
(43) Pub. Date: Mar. 7, 2024

(54) BATTERY PACK ELECTRICAL CONNECTION SYSTEM AND METHOD FOR ELECTRICALLY CONNECTING BATTERY PACK COMPONENTS

(71) Applicant: Ford Global Technologies, LLC, Dearborn, MI (US)

(72) Inventor: Alex Revels, Canton, MI (US)

(21) Appl. No.: 18/183,371

(22) Filed: Mar. 14, 2023

Related U.S. Application Data
(60) Provisional application No. 63/403,445, filed on Sep. 2, 2022.

(51) Int. Cl. H01M 50/507; H01M 50/517

(52) U.S. Cl. CPC H01M 50/507; H01M 50/517

(57) ABSTRACT

An electrical connection system for a traction battery pack includes a first electrical contact, a second electrical contact, and at least one rivet that connects the first electrical contact directly to the second electrical contact. A method of electrically connecting components within a traction battery pack includes aligning a first aperture within a first electrical contact relative to a second aperture within a second electrical contact, and electrically connecting the first electrical contact to the second electrical contact using a rivet having a shaft that extends through both the first aperture and the second aperture. The rivets can be pyrotechnic rivets.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to electrical connections within a traction battery pack.

### BACKGROUND

A traction battery pack of an electrified vehicle can include groups of battery cells arranged in one or more cell stacks. The traction battery pack can include electrical connection systems that connect components of the traction battery pack. Electrical connection systems can also be used to connect components of the traction battery pack to components outside the traction battery pack.

### SUMMARY

In some aspects, the techniques described herein relate to an electrical connection system for a traction battery pack, including: a first electrical contact; a second electrical contact; and at least one rivet that connects the first electrical contact directly to the second electrical contact.

In some aspects, the techniques described herein relate to an electrical connection system, wherein the first electrical contact is a first busbar electrically connected to first battery terminal of a first battery, and the second electrical contact is a second busbar electrically connected to a second battery terminal of a second battery.

In some aspects, the techniques described herein relate to an electrical connection system, wherein the first battery is within a first cell stack and the second battery is within a different, second cell stack.

In some aspects, the techniques described herein relate to an electrical connection system, wherein the at least one rivet is configured to rupture in response to a thermal energy level exceeding a threshold.

In some aspects, the techniques described herein relate to an electrical connection system, wherein the at least one rivet includes a hollow shaft extending between a factory head and a deformed head.

In some aspects, the techniques described herein relate to an electrical connection system, further including a pyrotechnic held within the hollow shaft.

In some aspects, the techniques described herein relate to an electrical connection system, wherein a shaft of the at least one rivet is received within both a first aperture of the first electrical contact and within a second aperture of the second electrical contact.

In some aspects, the techniques described herein relate to an electrical connection system, wherein the rivet includes a chamber holding a pyrotechnic.

In some aspects, the techniques described herein relate to an electrical connection system, wherein the first electrical contact and the second electrical contact are within an enclosure of the traction battery pack.

In some aspects, the techniques described herein relate to an electrical connection system, wherein the rivet is aluminum.

In some aspects, the techniques described herein relate to an electrical connection system, wherein a pyrotechnic rivet.

In some aspects, the techniques described herein relate to an electrical connection system, further including a spring sandwiched between the first electrical contact and the second electrical contact, the spring biasing the first electrical contact away from the second electrical contact.

In some aspects, the techniques described herein relate to an electrical connection system, wherein the first electrical contact is a first busbar, and the second electrical contact is a second busbar.

In some aspects, the techniques described herein relate to a method of electrically connecting components within a traction battery pack, including: aligning a first aperture within a first electrical contact relative to a second aperture within a second electrical contact; and electrically connecting the first electrical contact to the second electrical contact using a rivet having a shaft that extends through both the first aperture and the second aperture.

In some aspects, the techniques described herein relate to a method, further including holding a pyrotechnic within the rivet, the pyrotechnic configured to detonate to decouple the first electrical contact from the second electrical contact when a thermal energy level exceeds a threshold thermal energy level.

In some aspects, the techniques described herein relate to a method, further including biasing the first electrical contact away from the second electrical contact.

In some aspects, the techniques described herein relate to a method, wherein the first electrical contact is a first busbar joined directly to a first terminal of a first battery, and the second electrical contact is a second busbar joined directly to a second terminal of a second battery.

In some aspects, the techniques described herein relate to a method, wherein the first battery is within a first cell stack of a traction battery pack, and the second battery is within a second cell stack of the traction battery pack.

In some aspects, the techniques described herein relate to a method, wherein the first electrical contact is connected to the second electrical contact exclusively through the rivet.

In some aspects, the techniques described herein relate to a method, wherein the rivet is a pyrotechnic rivet.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 illustrates a battery cell from the traction battery pack of FIG. 2.

FIG. 4 illustrates an exemplary embodiment of an electrical connection system at Area 1 in FIG. 2 prior to joining a first electrical contact to a second electrical contact.

FIG. 5 illustrates the electrical connection system of FIG. 4 after joining the first electrical contact to the second electrical contact using a rivet.

FIG. 6 illustrates a section view at line 6-6 in FIG. 5.

FIG. 7 illustrates the section view from FIG. 6 after the rivet has been ruptured.

### DETAILED DESCRIPTION

This disclosure details exemplary systems that electrically connect together components of a traction battery pack. The electrical connection systems rely on at least one rivet, which can be a pyrotechnic rivet.

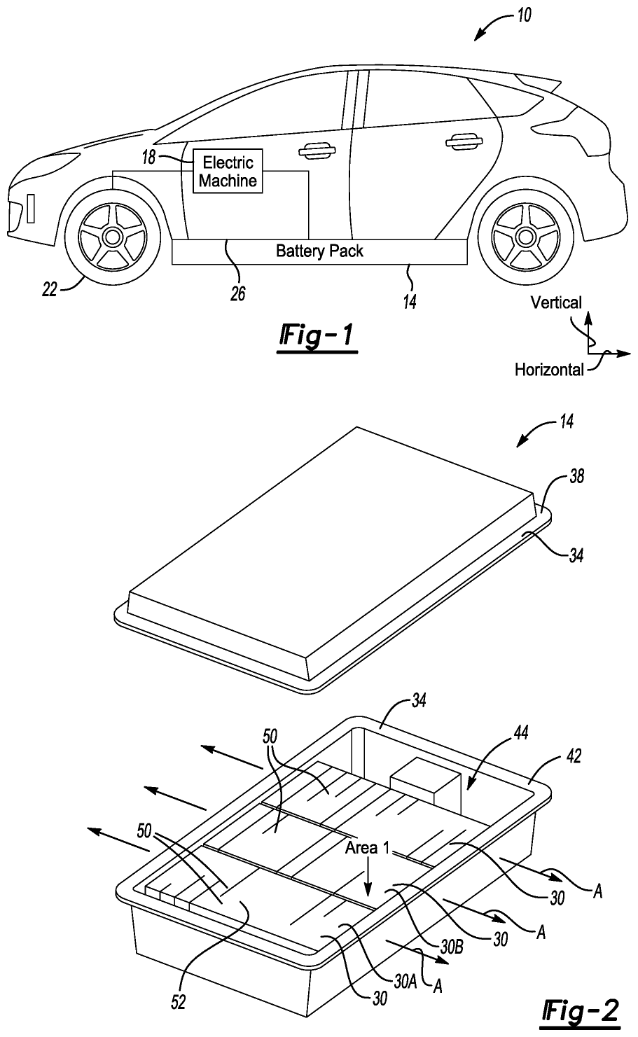

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

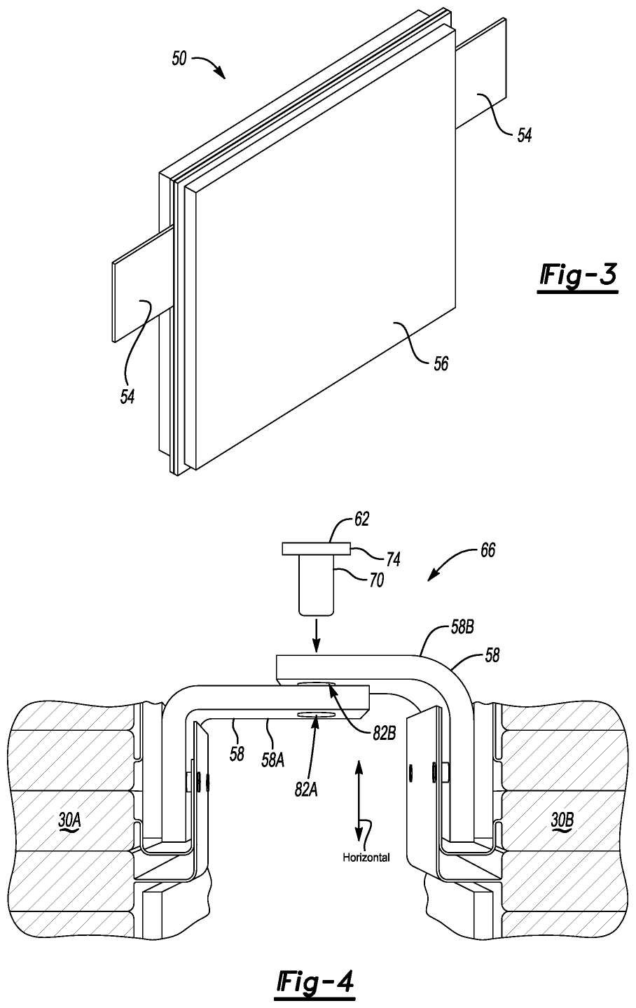

With reference now to FIGS. 2 and 3, the traction battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes, among other things, a plurality of battery cells 50 (or simply “cells”) stacked side-by-side relative to each along a respective cell stack axis A. The battery cells 50 store and supply electrical power. In this example, the axes A of the cell stacks 30 are parallel to each other and extend longitudinally in a cross-vehicle direction. Although a specific number of the cell stacks 30 and cells 50 are illustrated in the various figures of this disclosure, the traction battery pack 14 could include any number of the cell stacks 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure.

Each of the example battery cells 50 includes a pair of tab terminals 54 extending from case 56. Within a given one of the cell stacks 30, the individual battery cells 50 can be electrically connected together. To provide these electrical connections, the tab terminals 54 of the battery cells 50 can be connected to the tab terminals 54 of other battery cells 50.

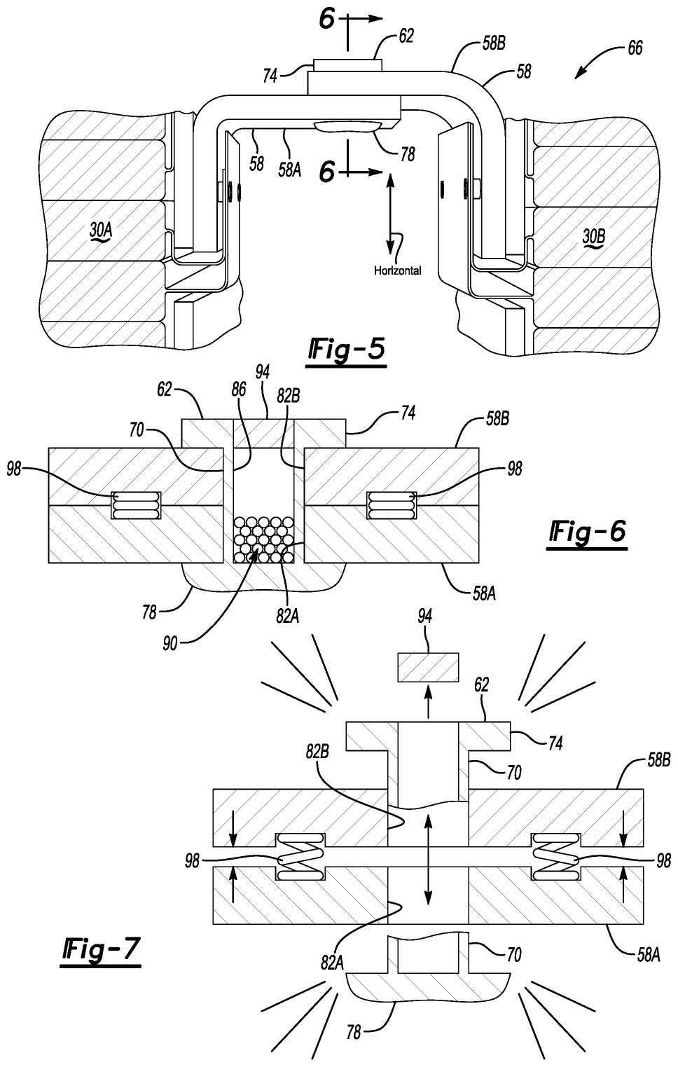

With reference to FIGS. 4 and 5, each of the cell stacks 30 includes at least one electrical contact 58. The cell stacks 30 can be electrically connected to another component through the at least one electrical contact 58. The at least one electrical contact 58 can be considered a primary or main electrical contact 58 for the cell stack 30.

In the exemplary embodiment, a first electrical contact 58A of the cell stack 30A connects to an second electrical contact 58B of the cell stack 30B. Connecting the first electrical contact 58A to the second electrical contact 58B electrically connects together the two cell stacks 30A an 30B. The cell stacks 30 of the battery pack 14 can include additional electrical contacts 58 that are used electrically connect the cell stacks 30 to other cell stacks 30 or to other components of the traction battery pack 14.

At least one rivet 62 is used to connect the electrical contact 58A directly to the electrical contact 58B. The rivet 62, the electrical contact 58A, and the electrical contact 58B collectively provide an electrical connection system 66. In this exemplary embodiment, the electrical connection system 66 includes the rivet 62 and no other rivets. In another example, more than one rivet could be used to connect the first electrical contact 58A directly to the second electrical contact 58B.

The traction battery pack 14 can include a plurality of the electrical connection systems 66 used to connect the cell stacks 30 to each other and to other components. For example, the electrical connection systems 66 could be utilized to electrically connect the cell stacks 30 to other components of the traction battery pack 14, such as a busbar module. The electrical connection systems 66 could be used to electrically connect together components outside the traction battery pack 14. Thus, although described as electrically connecting together cell stacks 30, the electrical connection systems 66 are not limited to electrically connecting together the cell stacks 30.

In this example, the electrical contact 58A is a first busbar electrically connected to at least one first battery terminal 54A of at least one first battery cell 50 within one of the cell stacks 30. The second electrical contact 58B is a second busbar electrically connected to at least one second battery terminal 54B of a different, second battery cell 50 within another of the cell stacks 30B.

In the exemplary embodiment, the rivet 62, when installed, includes a shaft 70 extending between a factory head 74 and a deformed head 78. The first electrical contact 58A and the second electrical contact 58B are clamped between the factory head 74 and the deformed head 78 of the rivet 62 when the rivet 62 is joining the first electrical contact 58A to the second electrical contact 58B.

The first electrical contact 58A includes a first aperture 82A, and the second electrical contact 58B includes a second aperture 82B. The shaft 70 of the rivet 62 is received within the first aperture 82A and the second aperture 82B when joining the first electrical contact 58A to the second electrical contact 58B.

Electrically connecting the first electrical contact 58A to the second electrical contact 58B can involve aligning the first aperture 82A relative to the second aperture 82B, and then inserting the shaft 70 into the first aperture 82A and the second aperture 82B and riveting. The first electrical contact 58A and the second electrical contact 58B are then electrically coupled by riveting.

The first electrical contact 58A is connected to the second electrical contact 58B exclusively through the rivet 62 in this example. In another example, welds or threaded connectors could be used in addition to the rivet 62.

The example rivet 62 is aluminum. In another example, the rivet 62 is copper. Other materials could be used in other examples.

With reference to FIGS. 6 and 7, in the exemplary embodiment, the rivet 62 is a pyrotechnic rivet or “pyro” rivet. More specifically, the shaft 70 of the example rivet 62 is hollow and includes a chamber 86. A pyrotechnic 90 is held within the chamber 86. Certain conditions can cause the pyrotechnic 90 to detonate or combust. The conditions could be a thermal energy level exceeding a threshold level, for example. The rivet 62 is thus configured to rupture in response to the thermal energy level exceeding the threshold. The pyrotechnic 90 can be added to the chamber 86 after securing the rivet 62. A cap 94 can be used to hold the pyrotechnic 90 within the chamber 86.

Detonation of the pyrotechnic 90 can rupture the rivet 62 such that the first electrical contact 58A is electrically decoupled from the second electrical contact 58B. As thermal energy levels rise within the traction battery pack 14, electrically decoupling the first electrical contact 58A from the second electrical contact 58B can be desirable to break an electrical circuit within the traction battery pack 14.

In some examples, at least one spring 98 could be clamped between the first electrical contact 58A and the second electrical contact 58B. When the rivet 62 ruptures and is no longer holding the first electrical contact 58A and the second electrical contact 58B, the spring 98 urges the first electrical contact 58A away from the second electrical contact 58B to help ensure the electrical decoupling. When the spring 98 is incorporated into the electrical connection system 66, the first electrical contact 58A can be biased away from the second electrical contact 58B.

Riveting to connect to the first electrical contact 58A to the second electrical contact 58B applies less torque to the first electrical contact 58A and the second electrical contact 58B than, for example, connecting using a threaded mechanical fastener. Connecting through the rivet 62 also provides an electrical connection system 66 that can be serviced more easily than, for example, a welded connection.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A electrical connection system for a traction battery pack, comprising:
a first electrical contact;
a second electrical contact; and
at least one rivet that connects the first electrical contact directly to the second electrical contact.

2. The electrical connection system of claim 1, wherein the first electrical contact is a first busbar electrically connected to first battery terminal of a first battery, and the second electrical contact is a second busbar electrically connected to a second battery terminal of a second battery.

3. The electrical connection system of claim 2, wherein the first battery is within a first cell stack and the second battery is within a different, second cell stack.

4. The electrical connection system of claim 1, wherein the at least one rivet is configured to rupture in response to a thermal energy level exceeding a threshold.

5. The electrical connection system of claim 1, wherein the at least one rivet includes a hollow shaft extending between a factory head and a deformed head.

6. The electrical connection system of claim 5, further comprising a pyrotechnic held within the hollow shaft.

7. The electrical connection system of claim 1, wherein a shaft of the at least one rivet is received within both a first aperture of the first electrical contact and within a second aperture of the second electrical contact.

8. The electrical connection system of claim 1, wherein the rivet includes a chamber holding a pyrotechnic.

9. The electrical connection system of claim 1, wherein the first electrical contact and the second electrical contact are within an enclosure of the traction battery pack.

10. The electrical connection system of claim 1, wherein the rivet is aluminum.

11. The electrical connection system of claim 1, wherein a pyrotechnic rivet.

12. The electrical connection system of claim 11, further comprising a spring sandwiched between the first electrical contact and the second electrical contact, the spring biasing the first electrical contact away from the second electrical contact.

13. The electrical connection system of claim 1, wherein the first electrical contact is a first busbar, and the second electrical contact is a second busbar.

14. A method of electrically connecting components within a traction battery pack, comprising:
aligning a first aperture within a first electrical contact relative to a second aperture within a second electrical contact; and
electrically connecting the first electrical contact to the second electrical contact using a rivet having a shaft that extends through both the first aperture and the second aperture.

15. The method of claim 14, further comprising holding a pyrotechnic within the rivet, the pyrotechnic configured to detonate to decouple the first electrical contact from the second electrical contact when a thermal energy level exceeds a threshold thermal energy level.

16. The method of claim 15, further comprising biasing the first electrical contact away from the second electrical contact.

17. The method of claim 14, wherein the first electrical contact is a first busbar joined directly to a first terminal of a first battery, and the second electrical contact is a second busbar joined directly to a second terminal of a second battery.

18. The method of claim 17, wherein the first battery is within a first cell stack of a traction battery pack, and the second battery is within a second cell stack of the traction battery pack.

19. The method of claim 14, wherein the first electrical contact is connected to the second electrical contact exclusively through the rivet.

20. The method of claim 14, wherein the rivet is a pyrotechnic rivet.
